(19) United States
(12) Patent Application Publication
(10) Pub. No.: US 2013/0087552 A1
(43) Pub. Date: Apr. 11, 2013

(54) METHOD OF PREPARING CARBON-CARBON COMPOSITE FIBERS, AND CARBON HEATING ELEMENT AND CARBON HEATER PREPARED BY USING THE FIBERS

(71) Applicants: Youngjun LEE, Seoul (KR); Seongho Cho, Seoul (KR); Kapseung Yang, Gwangju (KR); Bohye Kim, Gwanju (KR); Changhyo Kim, Gwangju (KR); Donghun Lee, Gwangju (KR)

(72) Inventors: Youngjun LEE, Seoul (KR); Seongho Cho, Seoul (KR); Kapseung Yang, Gwangju (KR); Bohye Kim, Gwanju (KR); Changhyo Kim, Gwangju (KR); Donghun Lee, Gwangju (KR)

(21) Appl. No.: 13/645,747

(22) Filed: Oct. 5, 2012

(30) Foreign Application Priority Data
Oct. 5, 2011 (KR) 10-2011/0101330

(51) Int. Cl. H05B 3/02; D01F 9/12

(52) U.S. Cl. CPC H05B 3/023; D01F 9/12
USPC 219/553; 427/228; 428/368

(57) ABSTRACT

Provided is a method of preparing carbon-carbon composite fibers including forming a mixed solution including a carbon precursor and an organic solvent, dipping carbon fibers in the mixed solution, and performing a heat treatment on the dipped carbon fibers to convert the carbon precursor into a carbon material and impregnating the carbon fibers with the carbon material.

### CROSS-REFERENCE TO RELATED APPLICATIONS

The present application claims priority under 35 U.S.C. 119 and 35 U.S.C. 365 to Korean Patent Application No. 10-2011-0101330 (Oct. 5, 2011), which is hereby incorporated by reference in its entirety.

### BACKGROUND

The present disclosure relates to a method of preparing carbon-carbon composite fibers, and a carbon heating element and a carbon heater prepared by using the carbon-carbon composite fibers.

Carbon fibers (CFs) are denoted as a fibrous carbon material having a carbon content of 90% or more. Since carbon fibers may provide flexibility, high strength, high elasticity, and adsorptivity as well as fundamental characteristics retained in a carbon material, such as heat resistance, chemical stability, electrical conductivity, thermal conductivity, mechanical strength, and biocompatibility, carbon fibers may be used in various forms from a highly advanced material to a general-purpose material.

In particular, carbon fibers not only have high thermal conductivity and low thermal expansion coefficient, but also have high thermal shock resistance. Thus, many attempts have recently been made to use carbon fibers as an ultra-high temperature structural material instantaneously exposed to high heat, such as heating wires, heaters, frictional materials of airplanes, heat resistant materials of nuclear reactors, and rocket nozzles, by using the foregoing characteristics.

However, there may have many constraints in directly commercializing carbon fibers due to limitations in shape retention of carbon fibers and resistivity. In order to address such limitations, many attempts have typically been made, in which resistance is increased by increasing the lengths of carbon fibers or resistivity is decreased by vapor deposition of other metallic materials on surfaces of carbon fibers. However, such vapor deposition method may not only be inefficient, but may also generate toxic gas.

### SUMMARY

Embodiments provide carbon-carbon composite fibers having improved shape retention property, electrical conductivity, and stability.

In one embodiment, a method of preparing carbon-carbon composite fibers includes: forming a mixed solution including a carbon precursor and an organic solvent; dipping carbon fibers in the mixed solution; and impregnating the carbon fibers with carbon by heat treating the dipped carbon fibers.

In another embodiment, a carbon heating element includes a plurality of carbon-carbon composite fibers prepared by the foregoing method and has a resistivity in a range of about 0.5×10⁻³ Ω·cm to about 1.5×10⁻³ Ω·cm.

The details of one or more embodiments are set forth in the accompanying drawings and the description below. Other features will be apparent from the description and drawings, and from the claims.

### BRIEF DESCRIPTION OF THE DRAWINGS

FIG. 1 is a flowchart illustrating a method of preparing carbon-carbon composite fibers according to an embodiment;

FIG. 2 is photographs showing the carbon-carbon composite fibers according to the embodiment;

FIG. 3 is scanning electron micrographs showing the carbon-carbon composite fibers prepared by varying a concentration of pyrolized fuel oil (PFO), a carbon precursor material: (a) PFO 50 wt %, (b) PFO 80 wt %, (c) PFO 90 wt %;

FIG. 4 is scanning electron micrographs showing the carbon-carbon composite fibers prepared by varying a concentration of coal-tar pitch, a carbon precursor material: (a) 10 wt % of coal-tar pitch, (b) 13 wt % of coal-tar pitch;

FIG. 5 is scanning electron micrographs showing the carbon-carbon composite fibers prepared by varying a concentration of petroleum-based pitch: (a) 10 wt % of petroleum-based pitch, (b) 13 wt % of petroleum-based pitch;

FIG. 6 is a perspective view illustrating a carbon heater according to an embodiment; and

FIG. 7 is a perspective view illustrating a carbon heater according to another embodiment.

### DETAILED DESCRIPTION OF THE EMBODIMENTS

In the description of embodiments, it will be understood that when a substrate, layer, film, or electrode is referred to as being “on” and “under” another substrate, layer, film, or electrode, the terminology of “on” and “under” includes both the meanings of “directly” and “indirectly”. Also, the reference about ‘on’ and ‘under’ each element will be made on the basis of drawings. Since the thickness or size of each element in the drawings may be modified for convenience in description and clarity, the size of each element does not entirely reflect an actual size.

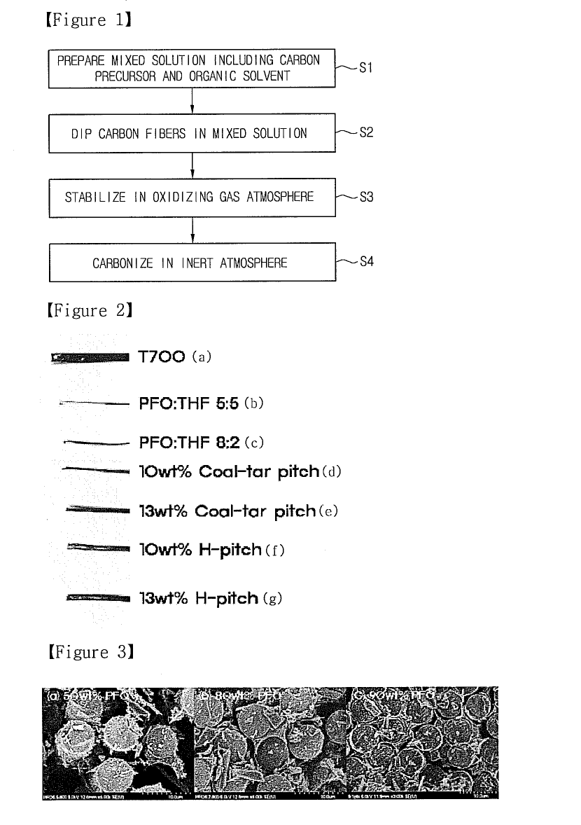

FIG. 1 is a flowchart illustrating a method of preparing carbon-carbon composite fibers according to an embodiment. Referring to FIG. 1, a method of preparing carbon-carbon composite fibers includes: forming a mixed solution including a carbon precursor and an organic solvent (S1); dipping carbon fibers in the mixed solution (S2); and coating the carbon fibers with carbon by heat treating the dipped carbon fibers. More particularly, the coating of the carbon fibers may include: stabilizing the dipped carbon fibers at a temperature ranging from about 50° C. to about 300° C. in a oxidizing gas atmosphere (S3); and carbonizing the oxidation stabilized carbon fibers at a temperature ranging from about 800° C. to about 1000° C. in an inert or vacuum atmosphere (S4).

First, a carbon precursor and an organic solvent are mixed to prepare a mixed solution (S1). The organic solvent used may be a material selected from the group consisting of dimethylacetamide (DMAc), N,N-dimethylformamide (DMF), tetrahydrofuran (THF), dimethyl sulfoxide (DMSO), and a combination thereof. More particularly, the organic solvent may be tetrahydrofuran.

The carbon precursor used may include a naphtha cracking residue, coal-tar pitch, petroleum pitch, polyacrylonitrile (PAN), phenol, and cellulose. Herein, the reside may include pyrolized fuel oil (PFO) generated in a naphtha cracking process. Thus, the embodiment may reduce production costs by using resides generated in a petroleum refining process as a carbon precursor. A solid phase carbon precursor, such as coal-tar pitch or petroleum pitch, among the carbon precursors may be dispersed in the organic solvent and a liquid phase carbon precursor, such as PFO, may be mixed with the organic solvent.

A concentration of the carbon precursor mixed in the solvent may be in a range of about 10 wt % to about 90 wt %. For example, a mixing ratio between the liquid phase carbon precursor and the solvent may be in a range of about 50 wt % to about 90 wt %, but the mixing ratio is not limited thereto. Also, a mixing ratio between the solid phase carbon precursor and the solvent may be in a range of about 10 wt % to about 15 wt %, but the mixing ratio is not limited thereto. The carbon fibers are coated with a greater amount of a carbon material as the concentration of the carbon precursor increases. As a result, resistivity of the carbon fibers coated with the carbon material may not only be decreased, but a shape retention property may also be improved.

Continuously, carbon fibers are dipped in the mixed solution (S2), and the dipped carbon fibers are heat treated to coat the carbon fibers with carbon (S3 and S4). A surface of the carbon fibers may be bonded or impregnated with a carbon material by the foregoing process. The carbon fibers may include a single carbon fiber or a plurality of carbon single fibers in a bundle shape. In the case that the carbon fibers are formed of a plurality of carbon single fibers, the plurality of carbon single fibers may be coated with the carbon material.

The carbon fibers may be dipped in the mixed solution for a few minutes to a few hours. Also, the dipping process may be repeated multiple times if necessary. The carbon fibers coated with the mixed solution thus prepared is stabilized at a temperature ranging from about 50° C. to about 300° C. in an oxidizing gas atmosphere. Thereafter, the oxidation stabilized carbon fibers are carbonized at a temperature ranging from about 800° C. to about 1000° C. in an inert or vacuum atmosphere.

Hereinafter, the present invention will be described in detail according to the following examples, but the present invention is not limited thereto.

### EXAMPLE 1

The T700 12 k (Toray Industries, Inc) was used as a carbon fiber and tetrahydrofuran (THF) was used as a solvent. Also, coal-tar pitch, petroleum pitch, and pyrolized fuel oil (PFO), a naphtha cracking residue, were used as a carbon precursor. Characteristics of the carbon precursors used in Examples are presented in Tables 1 and 2.

TABLE 1

| | State at room | Softening | H | O | N | S |
|---|---|---|---|---|---|---|
| | temperature | point C (%) | (%) | (%) | (%) | (%) |
| Coal-tar | Solid phase | 85.0 | 5.08 | — | 1.05 | — |
| pitch | | | | | | |
| Petroleum- | Solid phase | 295 | 5.4 | trace | — | — |
| based pitch | | | | | | |
| PFO | Liquid phase | — | 7.907 | 0.673 | 0.222 | — |

Table 1 shows the result of elemental analysis of the carbon precursors used. Since the pitches and PFO were all formed of carbon at a high ratio of about 90% or more, it may be confirmed that the pitches and PFO were suitable materials for being used as a carbon precursor. Also, in the following Table 2, molecular weights were measured by using chloroform as a solvent and gel permeation chromatography (GPC), and HI, TS, TI, PS, and PI were denoted as hexane soluble, toluene soluble, toluene insoluble, pyridine soluble, and pyridine insoluble, respectively.

TABLE 2

| | | | | Solubility (%) | | | |
|---|---|---|---|---|---|---|---|
| | M_{w} | Aromaticity | C/H | HI | TS | PI-TS | PI |
| Coal-tar | 200-3000 | 0.95 | 1.52 | — | — | — | — |
| pitch | | | | | | | |
| Petroleum- | 2229 | 0.87 | 1.45 | 95.6 | 62.8 | 36.4 | 0.8 |
| based pitch | | | | | | | |
| PFO | — | 0.68 | 1.02 | — | — | — | — |

Preparation of Mixed Solution Including Carbon Precursor

As shown in Table 3, carbon precursors having various ratios were dispersed in tetrahydrofuran solutions (Preparation Example 1 to Preparation Example 7). More particularly, PFO was used as a carbon precursor in Preparation Examples 1 to 3, and PFO and tetrahydrofuran solutions were mixed so as to have a mixed ratio of 50 wt %, 80 wt %, and 90 wt %, respectively. With respect to Preparation Examples 4 and 5, coal-tar pitch and tetrahydrofuran solutions were mixed so as to have a mixed ratio of 10 wt % and 13 wt %, respectively. Also, with respect to Preparation Examples 6 and 7, petroleum-based pitch and tetrahydrofuran solutions were mixed so as to have a mixed ratio of 10 wt % and 13 wt %, respectively.

TABLE 3

| | | Mixed ratio |
|---|---|---|
| | Carbon precursor | (dissolved in THF) |
| Preparation Example 1 | PFO | 50 wt % |
| Preparation Example 2 | PFO | 80 wt % |
| Preparation Example 3 | PFO | 90 wt % |
| Preparation Example 4 | Coal-tar pitch | 10 wt % |
| Preparation Example 5 | Coal-tar pitch | 13 wt % |
| Preparation Example 6 | Petroleum-based pitch | 10 wt % |
| Preparation Example 7 | Petroleum-based pitch | 13 wt % |

Dip Coating

Caron fibers (Toray Industries, Inc., T700 12 k) were respectively dipped in mixed solutions prepared according to the foregoing method. More particularly, both ends of the carbon fibers were tied in order to prevent a phenomenon of fiber loosening, and the carbon fibers were then dipped in the mixed solutions according to Preparation Examples 1 to 7 for 1 hour, respectively.

Thereafter, the carbon fibers coated with the mixed solutions were dried while compressed air was supplied at a flow rate ranging from 5 mL/minute to 20 mL/minute by using a hot air circulator, and were stabilized by heating at a rate of 1° C./minute and maintaining at a temperature ranging from 200° C. to 300° C. in air for about 1 hour. Thereafter, the carbon fibers were heated to a temperature ranging from 800° C. to 1000° C. at a heating rate of 5° C./minute in an inert gas (N₂ or Ar gas) atmosphere and carbonized to prepare carbon-carbon composite fibers.

### EXPERIMENTAL EXAMPLE 1

FIG. 2 is photographs showing carbon fibers surface modified according to Preparation Examples 1 to 7 and Comparative Example. More particularly, (a) is Comparative Example showing carbon fibers without a surface treatment, (b) is the case of mixing 50 wt % of pyrolized fuel oil (PFO) with a tetrahydrofuran solution (Preparation Example 1), (c) is the case of mixing 80 wt % of PFO with a tetrahydrofuran solution (Preparation Example 2), (d) is the case of mixing 10 wt % of coal-tar pitch with a tetrahydrofuran solution (Preparation Example 4), (e) is the case of mixing 13 wt % of coal-tar pitch with a tetrahydrofuran solution (Preparation Example 5), (f) is the case of mixing 10 wt % of petroleum-based pitch with a tetrahydrofuran solution (Preparation Example 6), and (g) is a photograph showing carbon fibers surface treated by mixing 13 wt % of petroleum-based pitch with a tetrahydrofuran solution (Preparation Example 7). Referring to FIG. 2, it may be confirmed that the carbon fibers prepared according to Preparation Examples 1 to 7 had a shape in which the fibers were curled.

Also, FIGS. 3 through 5 are scanning electron micrographs showing cross sections of the carbon fibers surface modified according to Preparation Examples 1 to 7.

Referring to FIG. 3, FIGS. 3(a), 3(b), and 3(c) are carbon fibers surface treated according to Preparation Examples 1, 2, and 3, respectively. Referring to FIG. 3, it may be confirmed that PFO penetrated between carbon fibers to impregnate the carbon fibers with a carbon material. Also, it may be confirmed that the carbon fibers were impregnated with a greater amount of the carbon material as a weight ratio of PFO increased.

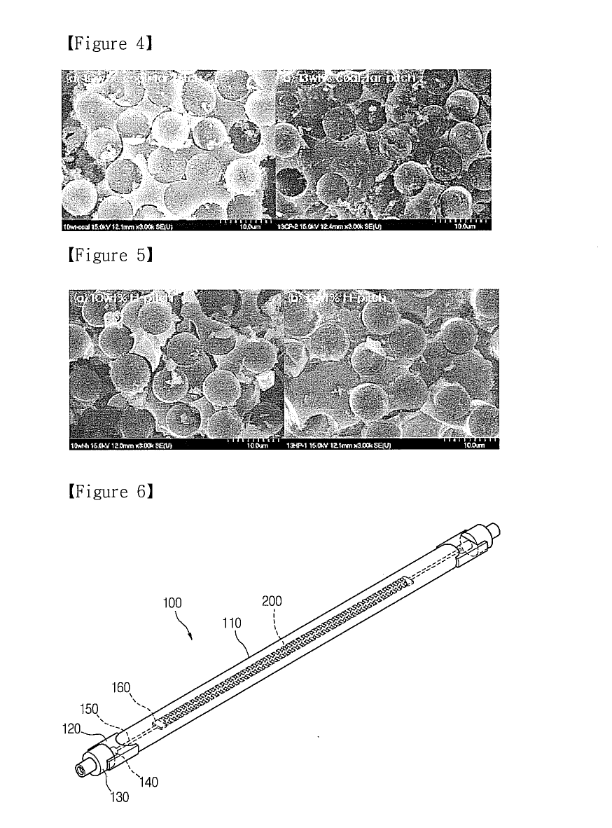

FIG. 4 is scanning electron micrographs showing carbon fibers according to Preparation Examples 4 and 5, and FIG. 5 is scanning electron micrographs showing carbon fibers according to Preparation Examples 6 and 7. Referring to FIGS. 4 and 5, it may be confirmed that the carbon fibers were coated with greater amounts of carbon materials in the case that weight percentages of pitch were increased.

Such phenomenon may be easily confirmed when yields in processes of preparing carbon-carbon composite fibers were investigated. Table 4 presents the results of investigating yields of carbon fibers prepared for each operation (S2, S3, and S4). The yields were calculated by using the following equation.

Yield=mass of carbon fibers for each operation/mass of (carbon fiber+Teflon)×100 [Equation 1]

TABLE 4

| | | Oxidation | |
|---|---|---|---|
| | Dipped carbon | stabilized carbon | Carbonized carbon |
| | fibers (S2) | fibers (S3) | fibers (S4) |
| Preparation Example 1 | 129% of CF + Teflon | 131% of CF + Teflon | 94% of CF + Teflon |
| Preparation Example 2 | 248% of CF + Teflon | 179% of CF + Teflon | 106% of CF + Teflon |
| Preparation Example 3 | 289% of CF + Teflon | 239% of CF + Teflon | 114% of CF + Teflon |
| Preparation Example 4 | 123% of CF + Teflon | 116% of CF + Teflon | 114% of CF + Teflon |
| Preparation Example 5 | 134% of CF + Teflon | 125% of CF + Teflon | 115% of CF + Teflon |
| Preparation Example 6 | 128% of CF + Teflon | 129% of CF + Teflon | 113% of CF + Teflon |
| Preparation Example 7 | 169% of CF + Teflon | 171% of CF + Teflon | 136% of CF + Teflon |

Electrical Characteristic Evaluation of Carbon-Carbon Composite Fibers

Electrical characteristics of carbon-carbon composite fibers according to Preparation Examples 1 to 7 were evaluated. More particularly, a voltage was applied to each carbon-carbon composite fiber to calculate a resistance value from a current value obtained and the resistance value was converted into a resistivity value, and the results thereof are presented in Table. 5. A length of each carbon fiber was fixed to 30 cm and the applied voltage was fixed to 60 V.

TABLE 5

| Sample | Resistivity (Ω · cm)* |
|---|---|
| Comparative Example 1 | 1.6 × 10⁻³ |
| Preparation Example 1 | 1.30 × 10⁻³ |
| Preparation Example 2 | 1.26 × 10⁻³ |
| Preparation Example 3 | 0.954 × 10⁻³ |
| Preparation Example 4 | 1.051 × 10⁻³ |
| Preparation Example 5 | 1.068 × 10⁻³ |
| Preparation Example 6 | 1.014 × 10⁻³ |
| Preparation Example 7 | 1.007 × 10⁻³ |

*Resistivity (Ω · cm) = resistance × cross-sectional area/length

It may be understood that resistivities of Preparation Examples 1 to 7 were decreased in comparison to that of Comparative Example 1. This indicated that resistivities of carbon fibers were decreased by impregnating carbon fibers with carbon precursors. Also, resistivity values were greatly decreased as contents of the carbon precursors, such as coal-tar pitch, petroleum-based pitch, and PFO, were increased and it may be understood that the result was matched with yield data (Table 4).

Referring to FIG. 6, a carbon heater 100 according to an embodiment include a tube 110 forming an accommodating space of internal articles and protecting the internal articles, and a carbon filament 200 disposed in the tube 110 and able to generate heat. The carbon heater 100 also includes a lead rod 150 supporting the carbon filament 200 not to be in contact with the tube 110 and a connecting portion 160 connecting one side of the lead rod 150 and the carbon filament 200.

Also, the carbon heater 100 includes a metal piece 140 connected to the other side of the lead rod 150 and electrically connecting between an external power supply and the carbon filament 200, and an insulation part 130 insulating the metal piece 140 from the outside. The carbon heater 100 further includes an encapsulation part 120 surrounding and supporting the metal piece 140, the insulation part 130, and the tube 110.

More particularly, the tube 110 is a portion accommodating articles, such as the carbon filament 200, inside thereof and acts to protect the articles as well as forming an accommodating space. Since the carbon heater 100 generates high heat, the tube 110 must be formed of a material having a predetermined stiffness and heat resistance. For example, the tube 110 may be a quartz tube. The tube 110 is self-sealed and isolates the carbon filament 200 from the outside. Since the tube 110 is configured as above, an inert gas able to decrease the consumption of the carbon filament 200 due to the generation of heat may be filled in the tube 110. Herein, the tube 110 may be formed in a linear shape.

The carbon filament 200 generates heat by applied electrical energy. The carbon filament 200 is substantially manufactured by weaving carbon-carbon composite fibers prepared by the foregoing method.

The plurality of connecting portions 160 is included and respectively connected to both ends of the carbon filament 200, and thus, connects the carbon filament 200 to the lead rod 150. As a result, the carbon filament 200 is in tension, and thus, may be maintained in a state of not being in contact with the tube 110 and may generate heat by being connected to the external power supply.

The lead rod 150 is connected to the carbon filament 200 by the connecting portion 160 and thus, maintains the carbon filament 200 in a state of being in tension. Then, the carbon heater 200 may stably generate heat without being in contact with the tube 100 during the generation of heat. A portion of the lead rod 150 extends to the outside of the tube 110. When configured as above, the carbon filament 200 disposed in tube 110 and the external power supply may be connected, while the self-sealed tube 110 is maintained in a sealed state.

The metal piece 140 is electrically connected to the external power supply. The metal tube 140 is connected to an end portion of the lead rod 150 extending to the outside of the tube 110 to transfer electrical energy of the external power supply to the carbon filament 200 through the lead rod 150. Then, the carbon filament 200 generates heat by receiving the electrical energy.

The insulation part 130 insulates a portion of the metal piece 140 exposed to the outside to prevent the metal piece 140 from the occurrence of a short circuit. In order to be reliably combined with an article to which the carbon heater 100 is fastened, the insulation part 130 has a shape able to be inserted into a predetermined portion of the article.

The encapsulation part 120 protects the end portion of the lead rod 150 extending to the outside of the tube 110 and connecting portions of the metal piece 140 from the outside. The encapsulation part 120 constitutes one assembly with the insulation part 130 and the tube 110 to support the carbon heater 100 to maintain a predetermined shape.

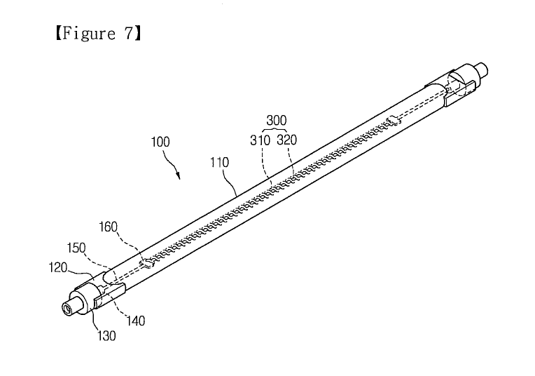

Referring to FIG. 7, a carbon heater 100 according to another embodiment includes a heat generating member 300 in a tube 110. Detailed descriptions related to the same elements as those shown in FIG. 6 among elements of the present embodiment will not be provided.

More particularly, the heat generating member 300 includes a carbon filament 310 and a second heat generating member 320 having different thermal expansion coefficients from each other. Herein, the carbon filament 310 may be substantially manufactured by weaving carbon-carbon composite fibers prepared by the foregoing method. The carbon filament 310 and the second heat generating member 320 are supported to each other and thus, a contact between the heat generating member 300 and the tube 110 may be prevented.

A method of preparing carbon-carbon composite fibers according to an embodiment may not only simplify a process by using a liquid phase deposition process instead of a gas phase deposition process typically used, but may also reduce processing costs.

A carbon content of carbon-carbon composite fibers prepared by the method according to the embodiment is increased by forming another carbon material on carbon fibers. Therefore, the carbon-carbon composite fibers according to the embodiment may facilitate their shape retention, may have improved processability, and may be suitable for preparing high-temperature heating element products having fixed shapes, such as heating wires and heaters. Also, electrical conductivity and thermal conductivity of the carbon-carbon composite fibers may be improved as the carbon content increases.

Further, the method of preparing carbon-carbon composite fibers according to the embodiment uses a waste having a relatively low production cost, such as pitch or naphtha cracking residues formed from petroleum residues, as a carbon precursor, and thus, may not only reduce production costs, but may also resolve environmental pollution problems.

Features, structures, or effects described in the foregoing embodiment are included in at least one embodiment of the present invention, and are not necessarily limited to only one embodiment thereof. Further, the features, structures, or effects exemplified in each embodiment may be combined or modified by those skilled in the art and implemented to other embodiments thereof. Therefore, descriptions related to such combinations and modifications will be construed as being included in the scope of the present invention.

Also, while this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. A method of preparing carbon-carbon composite fibers, the method comprising:
forming a mixed solution including a carbon precursor and an organic solvent;
dipping carbon fibers in the mixed solution; and
performing a heat treatment on the dipped carbon fibers to convert the carbon precursor into a carbon material and impregnating the carbon fibers with the carbon material.

2. The method according to claim 1, wherein a concentration of the carbon precursor in the mixed solution is in a range of about 10 wt % to about 90 wt %.

3. The method according to claim 1, wherein the carbon precursor comprises at least one selected from the group consisting of a naphtha cracking residue, coal-tar pitch, petroleum pitch, polyacrylonitrile (PAN), phenol, and a combination thereof.

4. The method according to claim 1, wherein the organic solvent comprises at least one selected from the group consisting of dimethylacetamide (DMAc), N,N-dimethylformamide (DMF), tetrahydrofuran (THF), dimethyl sulfoxide (DMSO), and a combination thereof.

5. The method according to claim 1, wherein the heat treatment comprises:
stabilizing the dipped carbon fibers at a temperature ranging from about 50° C. to about 300° C.; and
carbonizing the oxidation stabilized carbon fibers at a temperature ranging from about 800° C. to about 1000° C. in an inert or vacuum atmosphere.

6. The method according to claim 1, wherein the carbon fibers comprise a plurality of carbon single fibers and the plurality of carbon single fibers are coated with the carbon material.

7. A carbon heating element comprising a plurality of carbon-carbon composite fibers prepared by the method according to claim 1.

8. The carbon heating element according to claim 7, wherein a resistivity of the carbon heating element is in a range of about 0.9×10⁻³ Ω·cm to about 1.3×10⁻³ Ω·cm.

9. A carbon heater comprising:
a hollow tube; and
a carbon filament sealed in the tube and manufactured by using carbon-carbon composite fibers prepared by the method according to claim 1.

10. The carbon heater according to claim 9, wherein the carbon filament is manufactured by weaving the carbon-carbon composite fibers.

11. The carbon heater according to claim 9, wherein the carbon filament is manufactured by weaving the carbon-carbon composite fibers in a spiral shape.

12. The carbon heater according to claim 9, wherein the carbon filament is manufactured by weaving the carbon-carbon composite fibers in a hollow cylindrical shape.
